(19) United States
(12) Patent Application Publication
(10) Pub. No.: US 2015/0317841 A1
(43) Pub. Date: Nov. 5, 2015

(54) FARE EVASION DETECTION USING VIDEO ANALYTICS

(71) Applicant: Cubic Corporation, San Diego, CA (US)

(72) Inventors: Boris Karsch, Beaconsfield (AU); Steffen Reymann, Reigate (GB)

(21) Appl. No.: 14/701,081

(22) Filed: Apr. 30, 2015

Related U.S. Application Data
(60) Provisional application No. 61/986,702, filed on Apr. 30, 2014.

(51) Int. Cl. G07B 15/06; G06K 9/00; H04N 7/18

(52) U.S. Cl. CPC G07B 15/06; H04N 7/18; G06K 9/00711; G06K 9/00771; G06K 2009/00738

(57) ABSTRACT

Systems and techniques are presented for detecting fare evasion at a paid entry gate. A video feed is received from a video camera aimed at an area that includes the paid entry gate. The video feed is analyzed to detect a specific event. Fare collection data is received from a fare collection device. The fare collection device is located at the paid entry gate and configured to collect fare for passage through the paid entry gate. A determination is made that a proper fare has not been collected for the specific event based on the fare collection data. An alert is generated indicating that fare evasion is detected in response to determining that the proper fare has not been collected for the specific event.

### CROSS-REFERENCES TO RELATED APPLICATIONS

This application claims the benefit of U.S. Provisional Patent Application No. 61/986,702, filed Apr. 30, 2014, entitled “FARE EVASION DETECTION USING VIDEO ANALYTICS,” the entire disclosure of which is hereby incorporated by reference for all purposes.

### BACKGROUND

1. The Field of the Invention

The present invention generally relates to paid entry gates. More specifically, the present invention relates to fare evasion detection at paid entry gates.

2. The Relevant Technology

Turnstiles are typically used at entry gates of restricted areas to process users through the gates. The turnstile ensures that users can only pass through the gate in one direction and only one user can pass through at a time. A payment device can be used in conjunction with a turnstile to automate the fee collection and access granting processes. For example, a payment device that accepts coins, tokens, tickets, or cards can be placed next to the turnstile and can operate the turnstile to grant passage only if a valid payment has been received.

Turnstiles with payment devices can be used in a wide variety of settings to restrict access to paying customers. While turnstiles are most commonly found in mass transit systems, they can also be utilized at stadiums and sporting events, amusement parks and attractions, or any other setting where payment is collected in exchange for access to a restricted area.

### BRIEF SUMMARY

In one embodiment, a system for detecting fare evasion at a paid entry gate is presented. The system includes a video camera aimed at an area that includes the paid entry gate, a fare collection device located at the paid entry gate and configured to collect fare for passage through the paid entry gate, and a computer server system coupled to the video camera and the fare collection device. The computer server system is configured to receive a video feed from the video camera and analyze the video feed. A specific event is detected based on analyzing the video feed. The computer server system is further configured to receive fare collection data from the fare collection device and determine that a proper fare has not been collected for the specific event based on the fare collection data. The computer server system generates an alert indicating that fare evasion is detected in response to determining that the proper fare has not been collected for the specific event.

In another embodiment, a method for detecting fare evasion at a paid entry gate is presented. The method includes receiving a video feed from a video camera, the video camera being aimed at an area that includes the paid entry gate. The video feed is analyzed to detect a specific event. Fare collection data is received from a fare collection device. The fare collection device is located at the paid entry gate and configured to collect fare for passage through the paid entry gate. A determination is made that a proper fare has not been collected for the specific event based on the fare collection data and an alert is generated indicating that fare evasion is detected in response to determining that the proper fare has not been collected for the specific event.

In a further embodiment, a non-transitory computer-readable medium is presented. The non-transitory computer-readable medium has instructions stored therein, which when executed cause a computer to perform a set of operations including receiving fare collection data from a fare collection device. The fare collection device is located at a paid entry gate and configured to collect fare for passage through the paid entry gate. A specific event is detected based on the fare collection data. A video feed is received from a video camera, the video camera is aimed at an area that includes the paid entry gate. Further operations include analyzing the video feed and determining that a proper fare has not been collected for the specific event based on analyzing the video feed. An alert is generated indicating that fare evasion is detected in response to determining that the proper fare has not been collected for the specific event.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is an illustration of an example embodiment of a system for detecting fare evasion at a paid entry gate using video analytics.

FIG. 2 is a block diagram of one embodiment of a system for detecting fare evasion at a paid entry gate using video analytics.

FIG. 3 is a flowchart of one embodiment of a process for detecting fare evasion at a paid entry gate using video analytics.

FIG. 4 is an illustration of embodiments of a special-purpose computer system and a computing device that can be used to implement a system for detecting fare evasion at a paid entry gate using video analytics.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims. Further, when a particular feature, structure, or characteristic is described in connection with an embodiment, it is submitted that it is within the knowledge of one skilled in the art to effect such feature, structure, or characteristic in connection with other embodiments whether or not explicitly described.

Gate entry devices such as turnstiles can be placed at entry gates for controlling access to restricted areas. A payment device such as a coin collector or card reader can be used in conjunction with a gate entry device to fully automate the payment collection and access granting process. This can reduce or eliminate staffing requirements at entry gates to produce substantial savings in operating costs. However, reduced staffing can also have the undesirable effect of an increase in payment evasion or fare evasion. For example, users of a mass transit system can jump over turnstiles or use concession tickets to gain access without payment or with a reduced fare that the user is not entitled to.

Embodiments of the present invention use a video analytics system to detect fare evasion at a paid entry gate. The video analytics system receives input data in the form of a video feed from a video camera aimed at the paid entry gate. The video feed is analyzed to detect specific events. The output of the video analytics system can be combined with data from a fare collection device to make intelligent decisions about potential fare evasion activities. This can include monitoring of specific ticket presentation movements (e.g., presenting a smart card to a reader) and checking for electronic or visual input from the gate itself (e.g., text or visuals on the gate passenger display). In addition, an alert can be generated when fare evasion is detected to notify staff and help staff identify the perpetrators. This can result in increase in detection of fare evasion, which can further lead to revenue increases. Staff requirements can also be reduced and fare evasion statistics can be gathered to enable predictive alerts. Although examples and embodiments provided herein are described in the context of fare evasion detection for public transit systems, it is understood that embodiments are not so limited. Rather, the concepts described herein may be implemented in any environment where payment is collected in exchange for access to a restricted area, such as toll ways, stadiums, and amusement parks.

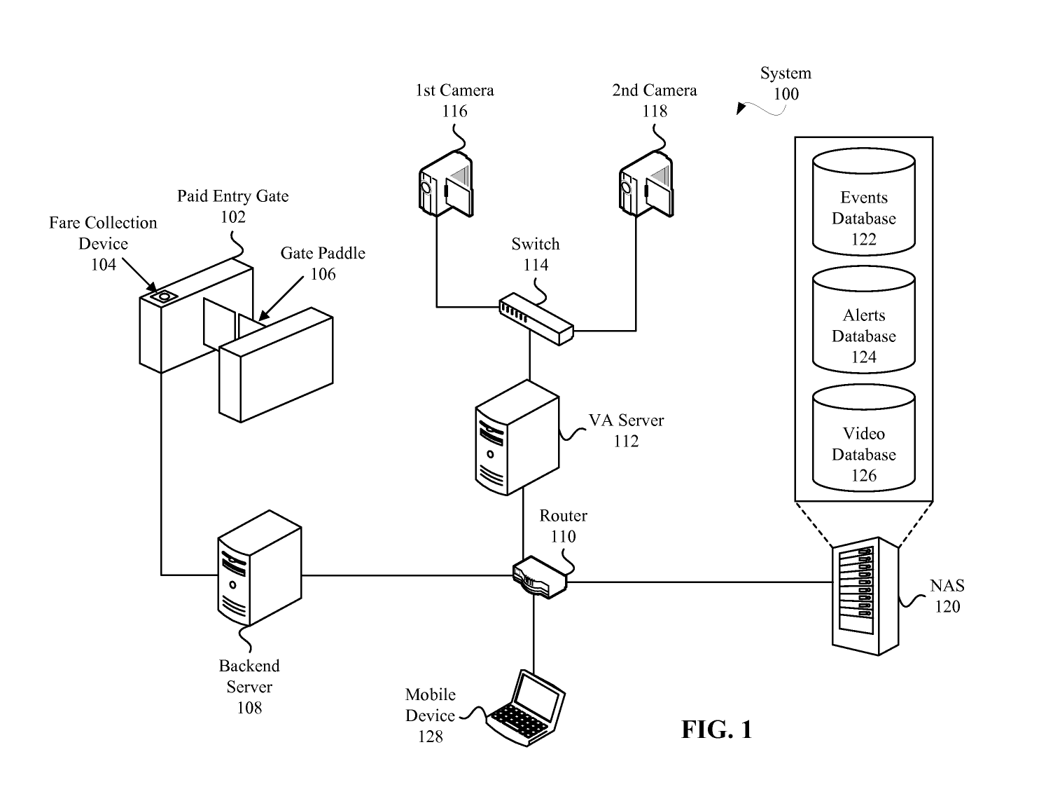

FIG. 1 is an illustration of an example embodiment of a system 100 for detecting fare evasion at a paid entry gate using video analytics. In this embodiment, system 100 includes a paid entry gate 102, which further includes a fare collection device 104 and gate paddle 106. Fare collection device 104 can be any device that can be used to collect payment or fare, such as a token, coin, ticket or cash collector; traditional or contactless card reader; or some other radio frequency (RF) transmitter that can communicate with, for example, a mobile device via protocols such as near field communication (NFC), Bluetooth, or Bluetooth low energy (BLE). Gate paddle 106 can perform the function of automatically granting access to a user when fare is collected by, for example, opening or unlocking to allow passage. Gate paddle 106 can also include sensors to detect the opening of the paddles by a user. Although gate paddle 106 is implemented with physical paddles in this embodiment, it is understood that other techniques can be used to implement gate paddle 106. For example, other embodiments can grant access by generating sensory notifications, such as a visual notification generated by activating a green colored light or an audible notification (e.g., speech or sound) generated by activating a speaker. Furthermore, optical turnstiles that use optical sensors, such as infrared sensors, can be used to detect users passing through the paid entry gate 102. While only one paid entry gate 102 is depicted in this figure for the sake of clarity, system 100 can include any number of paid entry gates 102, fare collection devices 104 and gate paddles 106.

System 100 further includes a backend server 108. Backend server 108 receives data from paid entry gate 102, such as fare collection data generated by fare collection device 104 or gate sensor data generated by gate paddle 106. Backend server 108 is also communicatively coupled with router 110, which is further coupled with video analytics (VA) server 112. VA server 112 is also coupled with first camera 116 and second camera 118 via switch 114. Switch 114 allows VA server 112 to communicate with multiple cameras by, for example, using packet switching or some other switching technology. It is understood that in other embodiments, the components of system 100 can be coupled in different ways while still providing for the same communication capabilities. For example, cameras 116 and 118 can be coupled with router 110 to establish communication with VA server 112, rather than through switch 114. Furthermore, backend server 108 and VA server 112 can be implemented as different software modules within a single server, rather than as two separate servers.

System 100 also includes one or more databases that are maintained in a network attached storage (NAS) 120. NAS 120 stores data for system 100 that is used to detect fare evasion and perform other functions and features described herein. NAS 120 can be any type of storage device that is accessible over a network, including a storage area network (SAN). In other embodiments, the databases can be stored in one of the servers 108 or 112 rather than on a separate physical machine dedicated to data storage.

In this embodiment, NAS 120 stores an events database 122, an alerts database 124 and a video database 126. Events database 122 can be used to store any number of specific events that VA server 112 uses to detect potential fare evasion activities when analyzing video feeds. Specific events can include, for example, jumping over or running through a closed gate, tailgating, unusual dwell time in gate area, height measurements or facial analysis measurements that can be used to determine that the age of a user is less than or equal to a preset threshold, specific visual gate output signals (e.g., on the passenger display), specific passenger movement to check for presentation of tickets to the gate reader, and gate paddle movement. Alerts database 124 can be used to store the different types and classifications of alerts that can be generated when fare evasion is detected. Video database 126 can be used to store videos generated by cameras 116 and 118. In some embodiments, video database 126 only stores clips of videos corresponding to when fare evasion is detected, rather than the entire video feed, to reduce memory requirements and processing times.

System 100 also includes mobile device 128, which can be communicatively coupled with router 110 via a wired or wireless connection. Mobile device 128 can be carried by staff members and can be used to alert staff when fare evasion is detected. Additionally, a video clip of the fare evasion event can be transmitted to mobile device 128 to help staff identify and capture perpetrators.

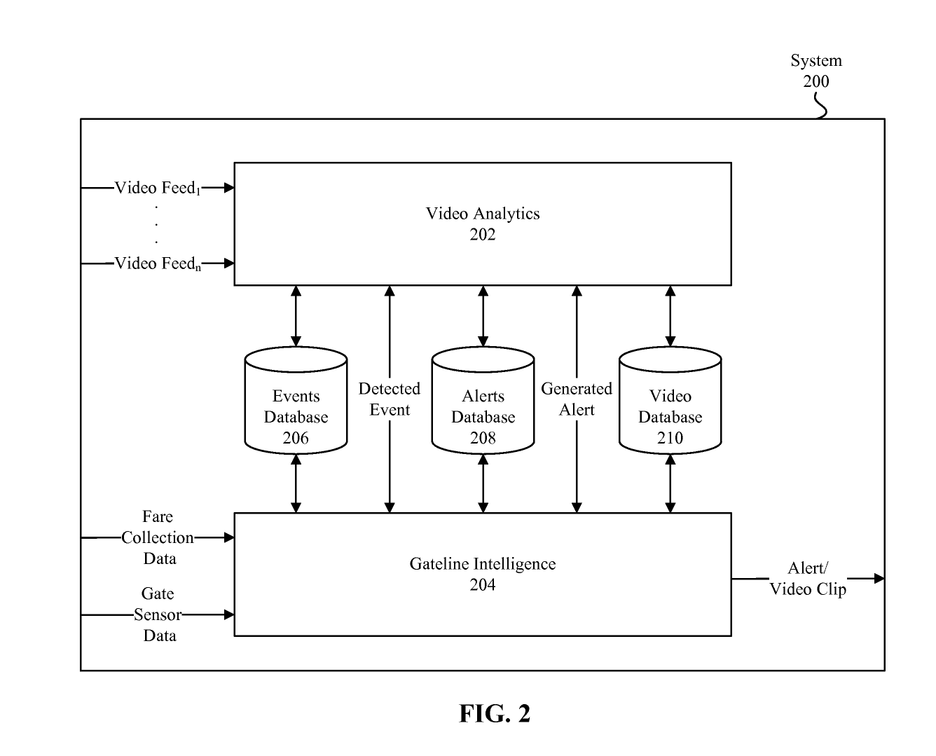

FIG. 2 is a block diagram of one embodiment of a system 200 for detecting fare evasion at a paid entry gate using video analytics. In this embodiment, system 200 includes video analytics module 202, gateline intelligence module 204, events database 206, alerts database 208 and video database 210.

Video analytics 202 receives input from one or more video cameras that generate video feeds. Video analytics 202 performs analysis on the video feeds to detect specific events that could indicate potential fare evasion activities. Video analytics 202 uses events database 206 to detect the events. For example, events database 206 can store predetermined motions or images that indicate potential fare evasion events. Video analytics 202 can detect the events during video feed analysis by matching the predetermined motions or images with motions or images detected in a video feed. In one embodiment, when a potential fare evasion event is detected in the video feed, video analytics 202 transmits an indicator of the detected event to gateline intelligence 204.

Gateline intelligence 204 also receives fare collection data from a fare collection device and gate sensor data from one or more gate sensors. When gateline intelligence 204 receives the indicator of a potential fare evasion event from video analytics 202, gateline intelligence 204 analyzes the fare collection data and/or gate sensor data to determine if proper fare was collected for the detected event. In one embodiment, fare collection data and gate sensor data corresponding to the detected event can be identified using timestamps. For example, the video feed can include a timestamp and when an event is detected, a time of day or a period of time can be associated with the event. Fare collection data and gate sensor data can also have a time of day associated with it, and the data can be matched with the event if the difference between the event time and the data time is less than or equal to a predetermined threshold, or if the data time falls within the period of time associated with the event.

Gateline intelligence 204 determines if an alert should be generated based on the detected event and the fare collection data and/or gate sensor data. In some embodiments, alerts can be further categorized by type or severity, such that different alerts are generated for different fare evasion events. For example, jumping over the gate or tailgating can be classified as high severity, using a concession ticket (e.g., a child or senior citizen ticket) that the user is not entitled to can be classified as medium severity, and crowding or unusual dwell time in the gate area can be classified as low severity. The different types or severities of alerts can be stored in alerts database 208, along with corresponding events and data, which can be used by gateline intelligence 204 to generate the proper alert when fare evasion is detected. In some embodiments, alerts database 208 can also be used to store specific instances of detected fare evasion and generated alerts, which can be used to generate statistical data. For example, the collected data on fare evasion can be processed periodically, such as every month, quarter, or year, to identify trends in fare evasion, such as peak times of fare evasion or demographic trends. The trends can then be used to predict when fare evasion is likely to occur, allowing for preemptive countermeasures during peak fare evasion times.

In this embodiment, when fare evasion is detected, gateline intelligence 204 transmits an indication of the generated alert to video analytics 202, instructing video analytics 202 to store a video clip of the event in video database 210. This reduces the amount of the memory that is required for video database 210 since only relevant portions of the video feed are stored. This can also reduce processing time for any further processing that may be performed on the video, since less video data is processed than if the entire video feed is stored. The duration of the stored clip can be determined based on the video analysis or the stored clip can have a predetermined duration. For example, video analysis can be performed to determine the start time and end time of the event. Alternatively, a predetermined duration can be used for all clips (e.g., 10 second duration or 30 second duration), or the duration can be selected from a number of predetermined durations based on the type of event that is detected (e.g., 20 seconds for jumping over the gate and one minute for crowding or unusual dwell time). In other embodiments, the entire video feed is stored and the transmission of an instruction is not required.

Gateline intelligence 204 outputs the alert to, for example, a mobile device of staff so that the perpetrator can be identified and apprehended. A video clip of the event can be transmitted with the alert to help with identification and for other purposes. For example, the video clip can be used as supporting evidence of the fare evasion if the perpetrator tries to deny the fact. In other embodiments, the alert can be transmitted to a sensory notification device, such as a speaker or a red colored light, to generate an alarm of the fare evasion.

In the above embodiments, the process for determining if fare evasion occurred is triggered by video analytics 202 when a specific event is detected in the video feed. Depending on the type of fare evasion, the process can also be triggered by gateline intelligence 204 based on fare collection data and/or gate sensor data in other embodiments. For example, if the type of fare evasion is jumping over the gate or tailgating, the process can be triggered when video analytics 202 detects the event in the video feed, in which case gateline intelligence 204 can then analyze the fare collection data/gate sensor data to verify whether proper fare was collected for the event. On the other hand, if the type of fare evasion is using a concession ticket that the user is not entitled to, the process can be triggered when gateline intelligence 204 detects that the concession ticket was used based on the fare collection data. In this embodiment, gateline intelligence 204 transmits an indicator of the detected event to video analytics 202, and video analytics 202 can then analyze the video feed to determine the age of the user by, for example, measuring the height of the user or performing facial analysis on the user. If the age of the user does not match the requirements of the concession ticket, video analytics 202 can transmit an indication of the type of alert to gateline intelligence 204 and gateline intelligence 204 can then generate and transmit the alert to notify staff.

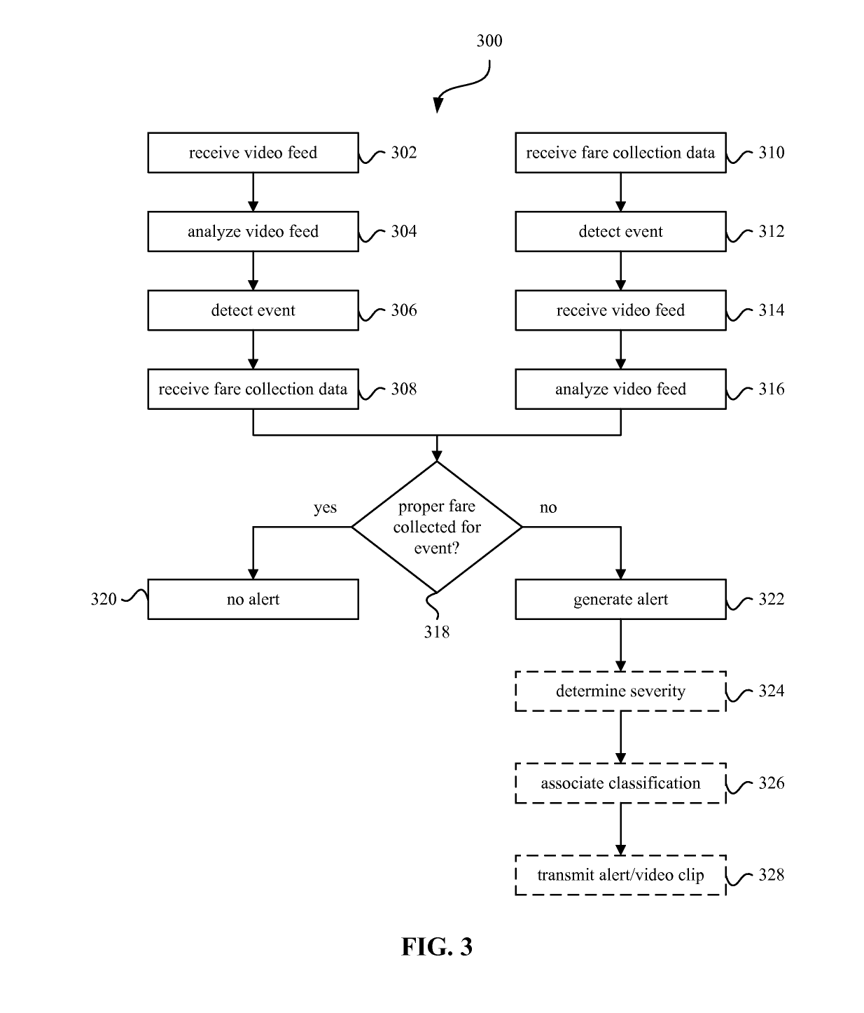

FIG. 3 is a flowchart of one embodiment of a process 300 for detecting fare evasion at a paid entry gate using video analytics. Process 300 can start at block 302 for fare evasion events that are initiated based on video feed analysis, or process 300 can start at block 310 for events that are initiated based on fare collection data.

At block 302, video feed from a video camera is received. The video camera is aimed at an area that includes the paid entry gate. At block 304, the video feed is analyzed and a specific event is detected based on the analysis at block 306. For example, the specific event that is detected can be jumping over a turnstile, tailgating, crowding, or unusual dwell time in gate area. At block 308, fare collection data is received from a fare collection device and at block 318, a determination is made of whether proper fare was collected for the event based on the fare collection data. For example, if tailgating is the event that was detected through video analysis, then proper fare was collected if the fare collection data indicates that two fares were collected for the event. However, if only one fare was collected for the event, then proper fare was not collected. Similarly, if the event is jumping over the turnstile, the fare collection data can be checked to see if any fare was collected around the time that the event occurred.

Alternatively, process 300 can start at block 310, where fare collection data is received. At block 312, a specific event is detected based on the fare collection data. The specific event can be, for example, that a concession ticket for a child or a senior citizen was used to gain access through the gate. At block 314, video feed from the video camera is received and the video feed is analyzed at block 316. Process 300 then continues to block 318 to determine if proper fare was collected for the event based on the video feed analysis. For example, if a senior citizen ticket was used, and facial analysis performed on the video feed indicates that the age of the user is less than the required age threshold, then proper fare was not collected.

If proper fare was collected, process 300 continues to block 320 and no alert is generated. If proper fare was not collected, an alert is generated at block 322. Optionally, a severity for the alert can be determined at block 324, and a classification can be associated with the alert based on the severity at block 326. At block 328, the alert and a video clip of the event can be transmitted to a mobile device carried by staff.

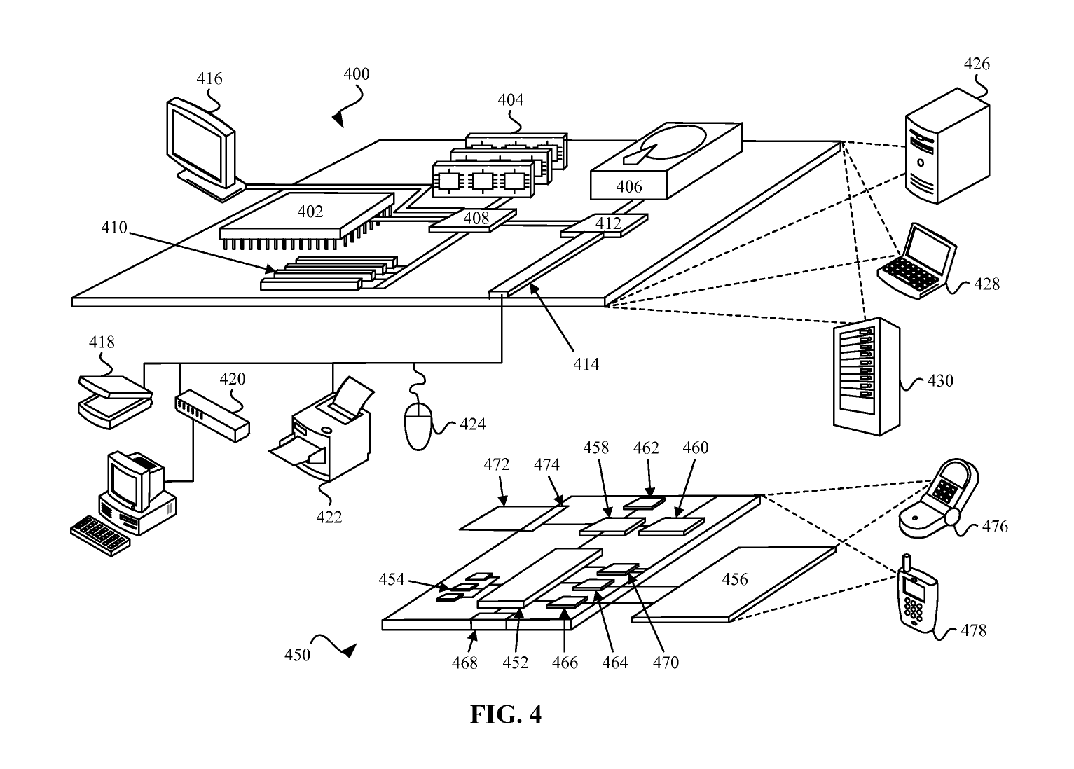

FIG. 4 is an illustration of embodiments of a special-purpose computer system 400 and a computing device 450 that can be used to implement a system for detecting fare evasion at a paid entry gate using video analytics. Special-purpose computer system 400 represents various forms of digital computers, such as laptops, desktops, workstations, personal digital assistants, servers, blade servers, mainframes, and other appropriate computers. Computing device 450 represents various forms of mobile devices, such as personal digital assistants, cellular telephones, smart phones, tablets, laptops and other similar computing devices.

Computer system 400 includes a processor 402, random access memory (RAM) 404, a storage device 406, a high speed controller 408 connecting to RAM 404 and high speed expansion ports 410, and a low speed controller 412 connecting to storage device 406 and low speed expansion port 414. The components 402, 404, 406, 408, 410, 412, and 414 are interconnected using various busses, and may be mounted on a common motherboard or in other manners as appropriate. Computer system 400 can further include a number of peripheral devices, such as display 416 coupled to high speed controller 408. Additional peripheral devices can be coupled to low speed expansion port 414 and can include an optical scanner 418, a network interface 420 for networking with other computers, a printer 422, and input device 424 which can be, for example, a mouse, keyboard, track ball, or touch screen.

Processor 402 processes instructions for execution, including instructions stored in RAM 404 or on storage device 406. In other implementations, multiple processors and/or multiple busses may be used, as appropriate, along with multiple memories and types of memory. RAM 404 and storage device 406 are examples of non-transitory computer-readable media configured to store data such as a computer program product containing instructions that, when executed, cause processor 402 to perform methods and processes according to the embodiments described herein. RAM 404 and storage device 406 can be implemented as a floppy disk device, a hard disk device, an optical disk device, a tape device, a flash memory or other similar solid-state memory device, or an array of devices, including devices in a storage area network or other configurations.

High speed controller 408 manages bandwidth-intensive operations for computer system 400, while low speed controller 412 manages lower bandwidth-intensive operations. Such allocation of duties is exemplary only. In one embodiment, high speed controller 408 is coupled to memory 404, display 416 (e.g., through a graphics processor or accelerator), and to high speed expansion ports 410, which can accept various expansion cards (not shown). In the embodiment, low speed controller 412 is coupled to storage device 406 and low speed expansion port 414. Low speed expansion port 414 can include various communication ports or network interfaces, such as universal serial bus (USB), Bluetooth, Ethernet, and wireless Ethernet.

Computer system 400 can be implemented in a number of different forms. For example, it can be implemented as a standard server 426, or multiple servers in a cluster. It can also be implemented as a personal computer 428 or as part of a rack server system 430. Alternatively, components from computer system 400 can be combined with other components in a mobile device (not shown), such as device 450. Each of such devices can contain one or more of computer system 400 or computing device 450, and an entire system can be made up of multiple computer systems 400 and computing devices 450 communicating with each other.

Computing device 450 includes a processor 452, memory 454, an input/output device such as a display 456, a communication interface 458, and a transceiver 460, among other components. The components 452, 454, 456, 458, and 460 are interconnected using various busses, and several of the components may be mounted on a common motherboard or in other manners as appropriate. Computing device 450 can also include one or more sensors, such as GPS or A-GPS receiver module 462, gyroscopes (not shown), and cameras (not shown), configured to detect or sense motion or position of computing device 450.

Processor 452 can communicate with a user through control interface 464 and display interface 466 coupled to display 456. Display 456 can be, for example, a thin-film transistor (TFT) liquid-crystal display (LCD), an organic light-emitting diode (OLED) display, or other appropriate display technology. Display interface 466 can comprise appropriate circuitry for driving display 456 to present graphical and other information to the user. Control interface 464 can receive commands from the user and convert the commands for submission to processor 452. In addition, an external interface 468 can be in communication with processor 452 to provide near area communication with other devices. External interface 468 can be, for example, a wired communication interface, such as a dock or USB, or a wireless communication interface, such as Bluetooth or near field communication (NFC).

Device 450 can also communicate audibly with the user through audio codec 470, which can receive spoken information and convert it to digital data that can be processed by processor 452. Audio codec 470 can likewise generate audible sound for the user, such as through a speaker. Such sound can include sound from voice telephone calls, recorded sound (e.g., voice messages, music files, etc.), and sound generated by applications operating on device 450.

Expansion memory 472 can be connected to device 450 through expansion interface 474. Expansion memory 472 can provide extra storage space for device 450, which can be used to store applications or other information for device 450. Specifically, expansion memory 472 can include instructions to carry out or supplement the processes described herein. Expansion memory 472 can also be used to store secure information.

Computing device 450 can be implemented in a number of different forms. For example, it can be implemented as a cellular telephone 476, smart phone 478, personal digital assistant, tablet, laptop, or other similar mobile device.

It is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A system for detecting fare evasion at a paid entry gate, the system comprising:
a video camera aimed at an area that includes the paid entry gate;
a fare collection device located at the paid entry gate and configured to collect fare for passage through the paid entry gate; and
a computer server system coupled to the video camera and the fare collection device, the computer server system being configured to:
receive a video feed from the video camera,
analyze the video feed,
detect a specific event based on analyzing the video feed,
receive fare collection data from the fare collection device,
determine that a proper fare has not been collected for the specific event based on the fare collection data, and
generate an alert indicating that fare evasion is detected in response to determining that the proper fare has not been collected for the specific event.

2. The system of claim 1, wherein the computer server system is further configured to:
determine a severity of the alert, and
associate a classification with the alert based on the severity.

3. The system of claim 1, wherein the computer server system is further configured to:
receive a timestamp with the video feed,
associate a first time of day with the specific event based on the timestamp,
associate a second time of day with the fare collection data, and
match the first time of day with the second time of day.

4. The system of claim 3, wherein the computer server system matches the first time of day with the second time of day by determining that a difference between the first time of day and the second time of day is less than or equal to a predetermined threshold.

5. The system of claim 3, wherein the computer server system is further configured to:
associate a period of time with the specific event, the period of time including the first time of day,
wherein the computer server system matches the first time of day with the second time of day by determining that the period of time includes the second time of day.

6. The system of claim 1, wherein the specific event that is detected includes at least two users passing through the paid entry gate, and wherein the fare collection data indicates that only one fare was collected for the specific event.

7. The system of claim 1, further comprising:
a gate paddle located at the paid entry gate,
wherein the specific event that is detected includes movement of the gate paddle.

8. A method for detecting fare evasion at a paid entry gate, the method comprising:
receiving a video feed from a video camera, wherein the video camera is aimed at an area that includes the paid entry gate;
analyzing the video feed;
detecting a specific event based on analyzing the video feed;
receiving fare collection data from a fare collection device, wherein the fare collection device is located at the paid entry gate and configured to collect fare for passage through the paid entry gate;
determining that a proper fare has not been collected for the specific event based on the fare collection data; and
generating an alert indicating that fare evasion is detected in response to determining that the proper fare has not been collected for the specific event.

9. The method of claim 8, wherein generating the alert includes activating at least one of a red colored light source and a speaker that generates an alarm.

10. The method of claim 8, further comprising:
determining that an age of a user passing through the paid entry gate is greater than or equal to a preset threshold based on analyzing the video feed,
wherein determining that the proper fare has not been collected includes determining that a concession fare for a child was collected based on the fare collection data.

11. The method of claim 10, wherein analyzing the video feed includes measuring a height of the user, and wherein the determination that the age of the user is greater than or equal to the preset threshold is made based on the measured height of the user.

12. The method of claim 10, wherein analyzing the video feed includes performing facial analysis on the user, and wherein the determination that the age of the user is greater than or equal to the preset threshold is made based on the facial analysis.

13. The method of claim 8, further comprising:
storing a history of generated alerts that indicate fare evasion; and
generating statistical data on fare evasion based on the history of generated alerts.

14. The method of claim 13, further comprising:
determining a time of day when fare evasion is at a peak rate based on the statistical data.

15. A non-transitory computer-readable medium, having instructions stored therein, which when executed cause a computer to perform a set of operations comprising:
receiving fare collection data from a fare collection device, wherein the fare collection device is located at a paid entry gate and configured to collect fare for passage through the paid entry gate;
detecting a specific event based on the fare collection data;
receiving a video feed from a video camera, wherein the video camera is aimed at an area that includes the paid entry gate;
analyzing the video feed;
determining that a proper fare has not been collected for the specific event based on analyzing the video feed; and
generating an alert indicating that fare evasion is detected in response to determining that the proper fare has not been collected for the specific event.

16. The non-transitory computer-readable medium of claim 15, having further instructions stored therein, which when executed cause the computer to perform a set of operations comprising:
extracting a clip from the video feed, the clip including the specific event; and
storing the clip in a storage device.

17. The non-transitory computer-readable medium of claim 16, having further instructions stored therein, which when executed cause the computer to perform a set of operations comprising:
transmitting the clip to a mobile device via a wireless data connection.

18. The non-transitory computer-readable medium of claim 16, having further instructions stored therein, which when executed cause the computer to perform a set of operations comprising:
determining a duration of the clip based on analyzing the video feed.

19. The non-transitory computer-readable medium of claim 16, wherein the extracted clip is of a predetermined duration.

20. The non-transitory computer-readable medium of claim 19, having further instructions stored therein, which when executed cause the computer to perform a set of operations comprising:
selecting the predetermined duration from a plurality of durations based on the specific event that is detected.
